(19) United States
(12) Patent Application Publication
(10) Pub. No.: US 2026/0176974 A1
(43) Pub. Date: Jun. 25, 2026

(54) AEROFOIL COMPONENT FOR A HIGH-PRESSURE OR INTERMEDIATE-PRESSURE TURBINE

(71) Applicant: ROLLS-ROYCE plc, London (GB)

(72) Inventors: Christopher J. CLARK, Derby (GB); Nicholas R. ATKINS, Derby (GB); John COULL, Derby (GB); Mark R. STOKES, Derby (GB)

(73) Assignee: ROLLS-ROYCE plc, London (GB)

(21) Appl. No.: 19/395,186

(22) Filed: Nov. 20, 2025

(30) Foreign Application Priority Data
Dec. 20, 2024 (GB) GB 2418777.5

(51) Int. Cl. F01D 5/14

(52) U.S. Cl. CPC F01D 5/141; F05D 2200/12; F05D 2200/13; F05D 2200/14; F05D 2220/323; F05D 2240/301; F05D 2240/303; F05D 2240/304

(57) ABSTRACT

An aerofoil component for a high-pressure or intermediate-pressure turbine of a multi-spool gas turbine engine having an aerofoil member which spans a working gas annulus of the gas turbine engine. The aerofoil member has pressure side and suction side aerofoil surfaces which each extend from a leading to a trailing edge such that transverse cross sections through the aerofoil member provide respective aerofoil sections. The spacing between the leading and trailing edges on the midspan aerofoil section defines a midspan axial chord length. The aerofoil member are arranged in a circumferential row around the annulus with plural, equally spaced, identical aerofoil members whereby the circumferential spacing of the aerofoil members at the trailing edges of their midspan aerofoil sections defines a midspan pitch of the aerofoil member. At midspan: the value of S/Cₓ is in the range from 1.4 to 1.6; and the uncovered turning angle is 16° or more.

### CROSS-REFERENCE TO RELATED APPLICATIONS

This specification is based upon and claims the benefit of priority from United Kingdom patent application number GB 2418777.5 filed on Dec. 20, 2024, the entire contents of which is incorporated herein by reference.

### BACKGROUND

### Technical Field

The present disclosure relates to an aerofoil component for a high-pressure or intermediate-pressure turbine.

### Description of the Related Art

In aero gas turbine engines, decreasing the number of aerofoil components (whether static guide vanes or rotating blades) in a given circumferential row of components in a turbine is generally beneficial as it not only reduces the weight of the turbine but also reduces the engine's cooling requirements thereby helping to improve engine specific fuel consumption. The reduced vane or blade count also lowers manufacturing costs. On the other hand, decreasing the number of aerofoil components beyond a certain level eventually compromises the total amount of power that the remaining components can extract from the working gas. In conventional aero engines, the balance of such considerations tends to lead to a vane or blade count that in a high-pressure (HP) turbine provides a value of S/Cₓ (where S is the pitch and Cₓ is the axial chord length of the aerofoil components of a given row, both typically measured at midspan) is about 1.3.

In modern aero gas turbine engines, increased efficiencies are obtained by reducing the size of the engine core relative to the fan diameter. However, as cores shrink, certain loss sources play an increasingly significant role in total entropy production, in particular loss sources that are associated with geometrical tolerance features, such as trailing edge loss, become more important.

However, improving the design of the aerofoil components within gas turbine engines is a complex technical process. Understanding the performance of these components is also critical to fault diagnosis and setting limits on operation. Computational Fluid Dynamics (CFD) is an essential tool used to model and characterise aerodynamic behaviour during design of aerofoil components found in turbomachinery. The flows encountered in turbines are three-dimensional, viscous, turbulent, and may be transonic. The only way to understand the behaviour of flow within a gas turbine is using modelling techniques, to reveal effects of flow through turbine blades and vanes. Self-evidently, aerodynamic behaviour within an operating gas turbine is extremely difficult to observe in operation due to the high temperatures, pressures and velocities present in the engine

The present disclosure has been devised in light of the above considerations.

### SUMMARY

For cooled aerofoil components operating in the hottest part of the engine, trailing edge loss is expected to become a much larger fraction of total profile (i.e. aerofoil surface) loss in future engines. Such components include HP vanes and blades, and may also include intermediate-pressure (IP) vanes and blades for future three spool engines. It has been found that by manipulating the geometry of aerofoil sections to produce aerofoil components with higher values of S/Cₓ, the trailing edge of a given component can be moved away from the peak suction position on an adjacent component. This movement to a region of higher static pressure is termed “over-diffusion”, and it enables lower trailing edge velocities and hence lower trailing edge loss. As higher values of S/Cₓ imply a reduced number of aerofoil components in a given circumferential row, such components may be described as “high-lift” or even “ultra-high-lift” components.

Thus, in a first aspect, the present disclosure provides an aerofoil component, such as a blade or vane, for a high-pressure or intermediate-pressure turbine of a multi-spool gas turbine engine, the component having an aerofoil member which, in use, spans a working gas annulus of the gas turbine engine; wherein the aerofoil member has pressure side and suction side aerofoil surfaces which each extend from a leading edge to a trailing edge of the aerofoil member such that transverse cross sections through the aerofoil member provide respective aerofoil sections, the spacing between the leading and trailing edges on the midspan aerofoil section defining a midspan axial chord length, Cₓ, of the aerofoil member, and the aerofoil member being arranged, in use, in a circumferential row around the annulus with plural, equally spaced, identical aerofoil members whereby the circumferential spacing of the aerofoil members at the trailing edges of their midspan aerofoil sections defines a midspan pitch, S, of the aerofoil member; and wherein the aerofoil member is configured such that at midspan: the value of S/Cₓ is in the range from 1.4 to 1.6; and the uncovered turning angle is 16° or more.

Advantageously, a value of S/Cₓ in the range from 1.4 to 1.6 combined with an uncovered turning angle of 16° or more, enables high-lift HP or IP blades or vanes which can lead to improved engine specific fuel consumption and reduced manufacturing costs. This can be particularly beneficial in the context of civil gas turbine engines, where the need to reduce fuel consumption and manufacturing costs is paramount.

Optional features of the present disclosure will now be set out. These are applicable singly or in any combination with any aspect of the present disclosure.

The value of S/Cₓ may be 1.4 or more but less than 1.5.

Preferably, the uncovered turning angle is 17° or more or 18° or more, and more preferably is 19° or more or 20° or more.

The aerofoil component may be configured such that, when the high-pressure or intermediate-pressure turbine has at least one stage formed by a circumferential row of identical ones of the aerofoil component, the average Mach number, M2, on exit from the or each stage is at least 0.8, and preferably is at least 0.9, M2 being calculated by performing CFD analysis at cruise condition of the gas turbine engine. M2 may be about 0.95. In particular, the uncovered turning angle may be greater than or equal to (35−20*M2)°, preferably is greater than or equal to (35.5−20*M2)°, and more preferably is greater than or equal to (36−20*M2)°.

The isentropic Mach number on the suction side aerofoil surface of the midspan aerofoil section, calculated by performing CFD analysis at cruise condition of the gas turbine engine, may increase from the leading edge to a peak value of Mₚₑₐₖ and then decreases to Mₜₑ at the trailing edge, the value of Mₚₑₐₖ/Mₜₑ being 1.35 or more and Mₜₑ being the time-averaged isentropic Mach number at the trailing edge.

Indeed, more generally, in a second aspect, the present disclosure provides an aerofoil component, such as a blade or vane, for a high pressure or intermediate-pressure turbine of a multi-spool gas turbine engine, the component having an aerofoil member which, in use, spans a working gas annulus of the gas turbine engine; wherein the aerofoil member has pressure side and suction side aerofoil surfaces which each extend from a leading edge to a trailing edge of the aerofoil member such that transverse cross sections through the aerofoil member provide respective aerofoil sections, the spacing between the leading and trailing edges on the midspan aerofoil section defining a midspan axial chord length, Cₓ, of the aerofoil member, and the aerofoil member being arranged, in use, in a circumferential row around the annulus with plural, equally spaced, identical aerofoil members whereby the circumferential spacing of the aerofoil members at the trailing edges of their midspan aerofoil sections defines a midspan pitch, S, of the aerofoil member; and wherein the aerofoil member is configured such that at midspan: the value of S/Cₓ is in the range from 1.4 to 1.6; and the isentropic Mach number on the suction side aerofoil surface of the midspan aerofoil section, calculated by performing CFD analysis at cruise condition of the gas turbine engine, increases from the leading edge to a peak value of Mₚₑₐₖ and then decreases to Mₜₑ at the trailing edge, the value of Mₚₑₐₖ/Mₜₑ being 1.35 or more and Mₜₑ being the time-averaged isentropic Mach number at the trailing edge.

Again, advantageously, a value of S/Cₓ in the range from 1.4 to 1.6 combined with Mₚₑₐₖ/Mₜₑ being 1.35 or more, enables high-lift HP or IP blades or vanes which can lead to improved engine specific fuel consumption and reduced manufacturing costs. This can be particularly beneficial in the context of civil gas turbine engines, where the need to reduce fuel consumption and manufacturing costs is paramount.

Further optional features of the present disclosure will now be set out. These are applicable singly or in any combination with the aerofoil component of the second aspect, or with the aerofoil component of the first aspect when the isentropic Mach number on the suction side aerofoil surface of the midspan aerofoil section has a value of Mₚₑₐₖ/Mₜₑ which his 1.35 or more.

The value of Mₚₑₐₖ/Mₜₑ may be 1.65 or less, and preferably is 1.55 or less.

As measured with distance along the midspan axial chord, the distance, Lₚₑₐₖ, of Mₚₑₐₖ from the leading edge may be such that Lₚₑₐₖ/Cₓ is 0.6 or less. Preferably Lₚₑₐₖ/Cₓ is is 0.5 or more.

As measured with distance along the midspan axial chord, the isentropic Mach number on the pressure side aerofoil surface of the midspan aerofoil section, also calculated by performing CFD analysis at the cruise condition, may increase from the leading edge to the beginning of a plateau section of length Lₚₛₑ and may then increase again from the end of the plateau section to the trailing edge, the isentropic Mach number on the pressure side aerofoil surface being a substantially constant value Mₚₗₐₜ over the length of the plateau section and Lₚₛₑ/Cₓ being 0.3 or more. Preferably Lₚₛₑ/Cₓ being 0.4 or less. As measured with distance along the midspan axial chord, Mₚₑₐₖ may occur within the length range of the plateau section. The aerofoil component may be configured such that, when the high-pressure or intermediate-pressure turbine has at least one stage formed by a circumferential row of identical ones of the aerofoil component, the average Mach number, M1, on entry to the or each stage, is such that Mₚₗₐₜ/M1≤0.8, M1 also being calculated by performing CFD analysis at the cruise condition. In a third aspect, the present disclosure provides a high-pressure or intermediate-pressure turbine of a multi-spool gas turbine engine, wherein the high-pressure or intermediate-pressure turbine has at least one stage formed by a circumferential row of identical ones of the aerofoil component according to the first or the second aspect.

In a fourth aspect, the present disclosure provides a multi-spool gas turbine engine having the high-pressure or intermediate-pressure turbine of the third aspect.

The disclosure includes the combination of the aspects and preferred features described except where such a combination is clearly impermissible or expressly avoided.

As would be readily understood by the skilled person, each aerofoil member (e.g. blade or vane) has a leading edge, a trailing edge, a pressure surface and a suction surface. Transverse cross sections through an aerofoil member provide respective aerofoil sections. Features of the geometry of the aerofoil body can be defined by the stacking of the aerofoil sections. In particular, an aerofoil member's “lean” (the progressive displacement, with distance from a side wall, of the stacking axis in a circumferential direction of the engine) and “sweep” (the progressive displacement, with distance from a side wall, of the stacking axis in the direction of overall air flow, i.e. ignoring swirl, through the engine) can be defined with reference to the locus of a stacking axis which passes through a common point of each aerofoil section. For example, the common point may be at the leading edge, trailing edge, the centroid of each aerofoil section or any point defined by a designer to achieve the physical shape required.

Typically the leading and trailing edges of the aerofoil member are not straight lines. Thus, we define the “span line” of a leading or trailing edge as the straight line connecting the end points of the edge, e.g. at respective endwalls. Further we define the “midspan position” of a leading or trailing edge as the position on that edge which is closest to the midpoint of its span line. We also define the “midspan aerofoil section” as the aerofoil section of the aerofoil member which contains the midspan positions of the leading and trailing edges. Indeed, when we state herein that a parameter is “at midspan”, we mean that that parameter is being determined at the midspan aerofoil section.

The “chord” of an aerofoil section is the straight line extending from the leading to the trailing edge of that section. Considering a given chord as a vector, it may be considered as be formed from two component vectors: a first one extending solely in the circumferential direction of the engine, and the second one extending primarily in the axial direction of the engine. The straight line described by the second vector is thus termed the “axial chord”, but this is not to ignore that it may also extend in the radial direction of the engine (e.g. if either or both of the side walls of the working gas annulus of the gas turbine engine are not cylindrical). The “axial chord length” is the length of the axial chord, and thus ignores any circumferential displacement between the leading and trailing edges.

The “camber line” extends from the leading edge to the trailing edge of an aerofoil section. Along circumferential directions in the plane of the aerofoil section, the camber line is equally spaced from the pressure and suction surfaces, and thus the camber line is typically curved. The camber line determines the “inlet angle” (or “metal inlet angle”) and “exit angle” (or “metal exit angle”) of the aerofoil section. The inlet angle is the acute angle between (i) the line of intersection of the plane of the aerofoil section and the longitudinal section of the engine that contains the leading edge of the aerofoil section and (ii) the direction of the camber line at the leading edge of the aerofoil section. The exit angle is the acute angle between (i) the line of intersection of the plane of the aerofoil section and the longitudinal section of the engine that contains the trailing edge of the aerofoil section and (ii) the direction of the camber line at the trailing edge of the aerofoil section. The “turning duty” of the aerofoil section is the difference between its inlet and exit angles.

Identical, equally spaced, aerofoil members are arranged in a circumferential row around the working gas annulus of the gas turbine engine. Neighbouring aerofoil members in the row thus define passages therebetween. The “throat” of such a passage is defined at a given an aerofoil section by the line which reaches across the passage perpendicularly from a point of departure on the suction surface of that aerofoil section of one aerofoil member to the trailing edge of the corresponding aerofoil section on the neighbouring aerofoil member. The “suction surface throat angle” at the aerofoil section is then the acute angle between (i) the line of intersection of the plane of the aerofoil section and the longitudinal section of the engine that contains that point of departure and (ii) the direction the suction surface makes on the aerofoil section at the point of departure.

The “uncovered turning angle” of an aerofoil section is the difference between the exit angle (A2) of the aerofoil section and the suction surface throat angle (SSTA) of the aerofoil section.

As used herein, “cruise condition” has the conventional meaning and would be readily understood by the skilled person. Thus, for a given gas turbine engine for an aircraft, the skilled person would immediately recognise cruise condition to mean the operating point of the engine at mid-cruise of a given mission (which may be referred to in the industry as the “economic mission”) of an aircraft to which the gas turbine engine is designed to be attached. In this regard, mid-cruise is the point in an aircraft flight cycle at which 50% of the total fuel that is burned between top of climb and start of descent has been burned (which may be approximated by the midpoint—in terms of time and/or distance—between top of climb and start of descent. Cruise condition thus defines an operating point of the gas turbine engine that provides a thrust that would ensure steady state operation (i.e. maintaining a constant altitude and constant Mach number) at mid-cruise of an aircraft to which it is designed to be attached, taking into account the number of engines provided to that aircraft. For example, where an engine is designed to be attached to an aircraft that has two engines of the same type, at cruise condition the engine provides half of the total thrust that would be required for steady state operation of that aircraft at mid-cruise.

In other words, for a given gas turbine engine for an aircraft, cruise condition is defined as the operating point of the engine that provides a specified thrust (required to provide—in combination with any other engines on the aircraft—steady state operation of the aircraft to which it is designed to be attached at a given mid-cruise Mach number) at the mid-cruise atmospheric conditions (defined by the International Standard Atmosphere according to ISO 2533 at the mid-cruise altitude). For any given gas turbine engine for an aircraft, the mid-cruise thrust, atmospheric conditions and Mach number are known, and thus the operating point of the engine at cruise condition is clearly defined.

Purely by way of example, the forward speed at the cruise condition may be any point in the range of from Mach 0.7 to 0.98, for example 0.75 to 0.9, for example 0.75 to 0.85, for example 0.76 to 0.84, for example 0.77 to 0.83, for example 0.78 to 0.82, for example 0.79 to 0.81, for example on the order of Mach 0.8, on the order of Mach 0.85 or in the range of from 0.8 to 0.85. Any single speed within these ranges may be part of the cruise condition. For some aircraft, the cruise condition may be outside these ranges, for example below Mach 0.7 or above Mach 0.9 or 0.98.

Purely by way of example, the cruise condition may correspond to standard atmospheric conditions (according to the International Standard Atmosphere, ISA) at an altitude that is in the range of from 10000 m to 15000 m, for example in the range of from 10000 m to 12000 m, for example in the range of from 10400 m to 11600 m (around 38000 ft), for example in the range of from 10500 m to 11500 m, for example in the range of from 10600 m to 11400 m, for example in the range of from 10700 m (around 35000 ft) to 11300 m, for example in the range of from 10800 m to 11200 m, for example in the range of from 10900 m to 11100 m, for example on the order of 11000 m. The cruise condition may correspond to standard atmospheric conditions at any given altitude in these ranges.

Purely by way of example, the cruise condition may correspond to an operating point of the engine that provides a known required thrust level (for example a value in the range of from 30 kN to 35 kN) at a forward Mach number of 0.8 and standard atmospheric conditions (according to the International Standard Atmosphere) at an altitude of 38000 ft (11582 m). Purely by way of further example, the cruise condition may correspond to an operating point of the engine that provides a known required thrust level (for example a value in the range of from 50 kN to 65 kN) at a forward Mach number of 0.85 and standard atmospheric conditions (according to the International Standard Atmosphere) at an altitude of 35000 ft (10668 m).

### BRIEF DESCRIPTION OF THE DRAWINGS

Embodiments and experiments illustrating the principles of the disclosure will now be discussed with reference to the accompanying figures in which:

FIG. 1 shows a longitudinal cross-section through a ducted fan gas turbine engine;

FIG. 2 shows schematically a close-up view of the HP turbine region indicated by dashed box C in FIG. 1;

FIG. 3 shows schematically midspan aerofoil sections of two adjacent aerofoil members of the HP turbine blades of FIG. 2;

FIG. 4 shows a plot summarising results from CFD studies at cruise condition for various aerofoil member geometries;

FIG. 5 shows schematic plots of Mach fraction against normalised surface length for the suction and pressure sides of an aerofoil section of an HP turbine blade; and

FIG. 6 shows a plot summarising results from further CFD studies at cruise condition for various aerofoil member geometries.

### DETAILED DESCRIPTION

Aspects and embodiments of the present disclosure will now be discussed with reference to the accompanying figures. Further aspects and embodiments will be apparent to those skilled in the art. All documents mentioned in this text are incorporated herein by reference.

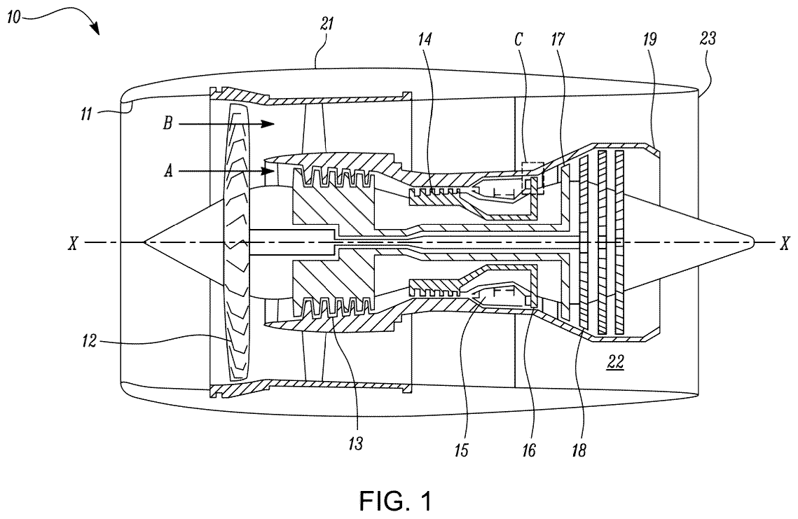

With reference to FIG. 1, a ducted fan, three spool gas turbine engine is generally indicated at 10 and has a principal and rotational axis X-X. The engine comprises, in axial flow series, an air intake 11, a propulsive fan 12, an intermediate pressure compressor 13, a high-pressure compressor 14, combustion equipment 15, a high-pressure turbine 16, an intermediate pressure turbine 17, a low-pressure turbine 18 and a core engine exhaust nozzle 19. A nacelle 21 generally surrounds the engine 10 and defines the intake 11, a bypass duct 22 and a bypass exhaust nozzle 23.

During operation, air entering the intake 11 is accelerated by the fan 12 to produce two air flows: a first air flow A into the intermediate-pressure compressor 13 and a second air flow B which passes through the bypass duct 22 to provide propulsive thrust. The intermediate-pressure compressor 13 compresses the air flow A directed into it before delivering that air to the high-pressure compressor 14 where further compression takes place.

The compressed air exhausted from the high-pressure compressor 14 is directed into the combustion equipment 15 where it is mixed with fuel and the mixture combusted. The resultant hot combustion products then expand through, and thereby drive the high, intermediate and low-pressure turbines 16, 17, 18 before being exhausted through the nozzle 19 to provide additional propulsive thrust. The high, intermediate and low-pressure turbines respectively drive the high and intermediate-pressure compressors 14, 13 and the fan 12 by suitable interconnecting shafts.

Other gas turbine engines to which the present disclosure may be applied may have alternative configurations. By way of example such engines may have an alternative number of interconnecting shafts (e.g. two) and/or an alternative number of compressors and/or turbines. The engine may have a propfan configuration, i.e. having one or more fore or aft propellors rather than a propulsive fan. Further the engine may comprise a gearbox provided in the drive train from a turbine to: a compressor, fan, or propeller.

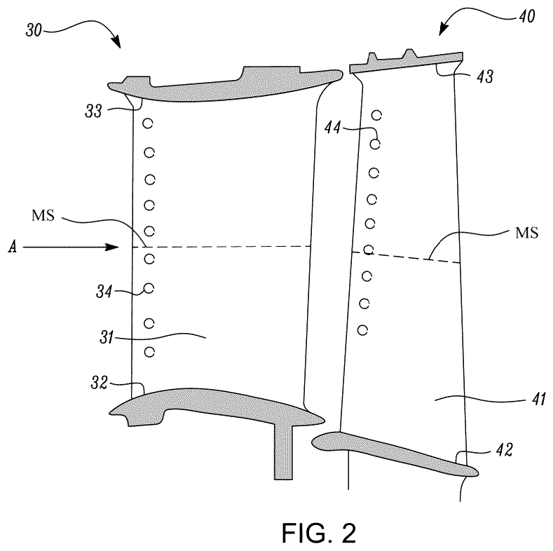

FIG. 2 shows schematically a close-up view of the region of the HP turbine 16 indicated by dashed box C in FIG. 1. The HP turbine 16 comprises a circumferential row of HP nozzle guide vanes (NGVs) 30 and a circumferential row of HP turbine blades 40. Each NGV 30 has an aerofoil member 31 extending between inner 32 and outer 33 endwalls which locally define inner and outer boundaries of a working gas annulus of the engine. Similarly, each blade 40 has an aerofoil member 41 extending between inner 42 and outer 43 endwalls. The NGVs 30 receive and rotate the flow A of the hot gas from the combustion equipment 15. The HP turbine blades 40 are then driven by the impulse of the rotating gas flow and its subsequent reaction as it accelerates through converging passages between the blades. The NGVs 30 and blades 40 are cooled by cooling air extracted from the exit of the HP compressor 14. This cooling air is directed into the hollow interiors of the NGVs 30 and blades 40 and then exits through respective arrays of holes 34, 44 to form external surface cooling films.

Each aerofoil member 31, 41 has a leading edge, a trailing edge, a pressure surface and a suction surface, and transverse cross sections through the member provide respective aerofoil sections. The position of the midspan aerofoil section (MS) of each aerofoil member 31, 41 is indicated in FIG. 2.

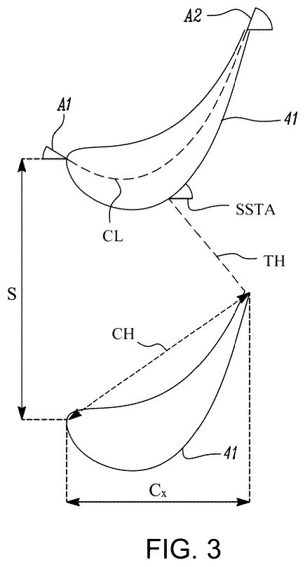

FIG. 3 then shows schematically the midspan aerofoil sections of two adjacent aerofoil members 41 of the HP turbine blades 40. The chord CH, axial chord length Cₓ, camber line CL, inlet angle A1, exit angle A2, midspan pitch S, throat TH of the passage between the aerofoil members 41, and the suction surface throat angle SSTA are indicated. The uncovered turning angle for the aerofoil section is the difference between the suction surface throat angle SSTA and the exit angle A2.

The IP turbine 17 likewise comprises a circumferential row of cooled IP NGVs and a circumferential row of cooled IP turbine blades.

There is a desire to reduce engine core size relative to fan diameter in next-generation gas turbine engines. However, with such core shrinkage, certain loss sources grow as a fraction of total entropy production, such as loss sources that are associated with geometrical tolerance features. In particular, for cooled aerofoil components such as HP/IP turbine blades and vanes, trailing edge loss is expected to become a much larger proportion of overall profile loss in the latest engines. However, by manipulating section geometries to provide higher values of S/Cₓ the trailing edge can be usefully moved away from peak suction on the adjacent blade, resulting in lower trailing edge velocities and hence lower trailing edge loss. Indeed, the over-diffusion can also lower blockage loss. These two benefits can, in combination, more than compensate for any rise in shear losses caused by increases in boundary layer thickness.

In more detail, the aerofoil member is formed from geometric aerofoil sections that locate the trailing edge further away from peak suction on the adjacent blade. In doing so, the trailing edge Mach number falls below the average Mach number (termed “M2”) on exit from the respective stage. This over-diffusion approach typically incurs an increased penalty due to boundary layer loss, but particularly for the relatively thick trailing edges found in certain HP/IP turbine blades and vanes, this can be outweighed by reduced trailing edge and blockage losses. In three-spool engines, such as those illustrated in FIGS. 1 to 3, the over-diffusion approach can be beneficially applied to the single row of HP turbine blades 40 and/or the single row of IP turbine blades typically found in such engines. In contrast, in two spool engines, which usually have a two stage turbine with two rows of HP turbine blades separated by a row of stator vanes, over-diffusion can be beneficially applied to both rows of blades and to the intermediate row of vanes. Thus, the present disclosure has general applicability to HP and IP turbines, including the HP and IP blades of three spool engines, and the HP blades and stator vanes of two spool engines.

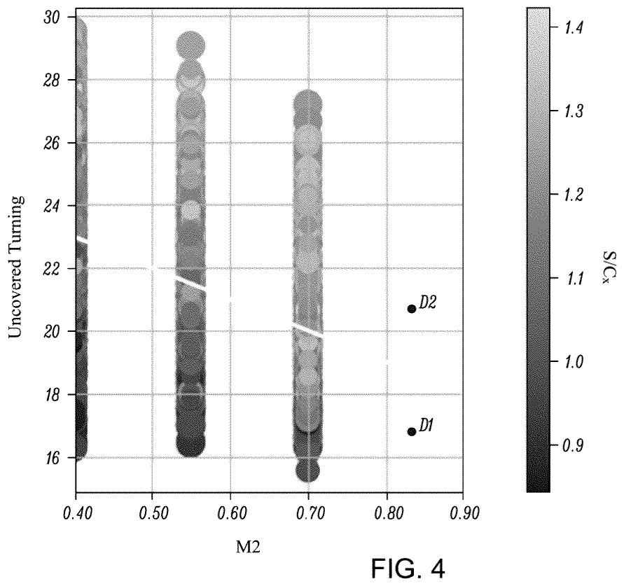

Over-diffusion can be conveniently achieved by increasing the level of uncovered turning performed by the aerofoil member of the blade or vane, e.g. the aerofoil member 41 of the blade 40. FIG. 4 shows a plot representative of a design space. It summarises results from CFD studies at cruise condition for various aerofoil member geometries, and in particular for different amounts of turning duty (which has a second order effect on the uncovered turning angle of each aerofoil member). In the plot, the position of each greyscale circle indicates the uncovered turning of a respective studied aerofoil member at a particular modelled value of M2. The lighter the grey of the circle, as indicated by the righthand scale, the higher the value of S/Cₓ for that aerofoil member.

Two trends are immediately identifiable from the plot of FIG. 4. Firstly, the range of uncovered turnings that can achieve a given M2 shifts downwards as M2 increases. Secondly, for each M2 value, lighter circles (higher values of S/Cₓ) predominate at the top of the range and darker circles (lower values of S/Cₓ) at the bottom.

The CFD studies explored in FIG. 4 are mainly at relatively low values of M2, i.e. in the range 0.4-0.7. However, the trends noted above are expected to persist to higher M2 values. In particular, in single stage HP turbines it is desirable for M2 to be about 0.95 or higher, whereas in two stage HP turbines it is desirable for M2 to be about 0.8-0.9 for both stages, the relatively high Mach numbers being needed in order to obtain a high specific work output per stage.

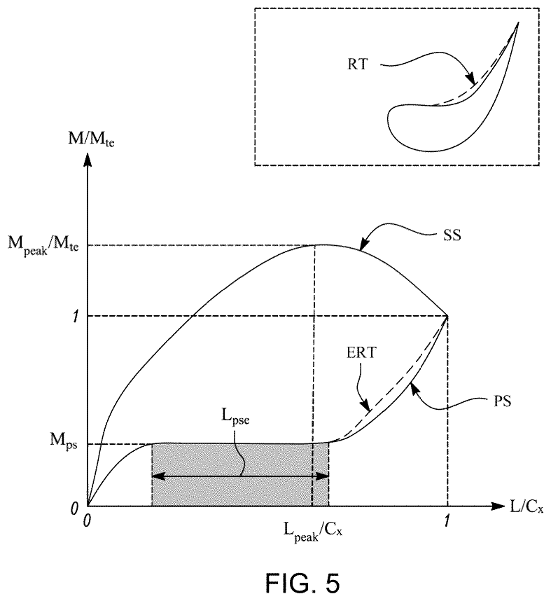

The over-diffusion approach enables a higher loading per blade or vane via an increased value of S/Cₓ. FIG. 5 shows schematically plots of Mach fraction against normalised surface length for the suction and pressure sides of an aerofoil section of an HP turbine blade. A similar plot can be produced for an aerofoil section of an IP turbine blade. The Mach fraction measured by the vertical axis is defined as the local isentropic Mach number, M, divided by the time-averaged isentropic Mach number at the trailing edge, Mₜₑ. This definition results in a value of 0 of the leading edge and a value of 1 at the trailing edge for both suction and pressure sides of all blades. The Mach numbers are calculated by performing CFD analysis at the cruise condition of the respective engine. The normalised surface position measured by the horizontal axis is defined as the distance, L, from the leading edge along the axial chord, divided by the axial chord length, Cₓ, corresponding to the respective position on the suction or pressure side of the aerofoil section. This definition also results in a value of 0 at the leading edge and a value of 1 at the trailing edge for both suction and pressure sides of all blades.

In FIG. 5, several parameters are highlighted. One is Mₚₑₐₖ/Mₜₑ, which is the normalised peak Mach number on the suction side SS. Conventional turbine blades are typically calculated to have Mₚₑₐₖ/Mₜₑ=1.3. However, in high-lift aerofoil members exhibiting over-diffusion, Mₚₑₐₖ/Mₜₑ is generally calculated to be above 1.35, and can be as high as 1.55. Another highlighted parameter in FIG. 5 is Lₚₑₐₖ/Cₓ, which is the normalised surface position at which Mₚₑₐₖ/Mₜₑ occurs. To increase lift, this value can be brought forward. Thus conventional turbine blades may have values of Lₚₑₐₖ/Cₓ which are greater than 0.6, but high-lift aerofoil members exhibiting over-diffusion typically have values of Lₚₑₐₖ/Cₓ which are 0.6 or less, for example down to 0.5.

FIG. 5 also illustrates a pressure side loading feature. In particular, the pressure side PS loading exhibits a “plateau” section of close to constant velocity, Mₚₗₐₜ, or very mild acceleration starting at a value of L/Cₓ of about 0.05 to 0.1, the plateau section being indicated by a shaded region in FIG. 5. At the other end of the plateau section, acceleration resumes and eventually peaks on the pressure side PS at the trailing edge. In conventional turbine blades, this plateau section, if it occurs at all, typically extends a distance Lₚₛₑ such that Lₚₛₑ/Cₓ is no more than 0.3. However, in high-lift aerofoil members exhibiting over-diffusion, it is preferable to extend the length of the plateau section such that that Lₚₛₑ/Cₓ is 0.3 or more. For example, Lₚₛₑ/Cₓ can be as high as 0.4. The extension of the plateau section can result in Mₚₑₐₖ lying within the extent of the plateau section.

Increasing Lₚₛₑ/Cₓ can tend to thin the rear part of the aerofoil section, which may negatively impact the mechanical performance of the aerofoil member. To compensate, therefore, this rear part of the aerofoil section can be re-thickened (see re-thickening RT in the insert box of FIG. 5 and the effect of re-thickening ERT in the graph shown in FIG. 5), thereby re-establishing its mechanical performance, as indicated in the inset box of FIG. 5. In such re-thickening RT, the suction side SS becomes less convex after the plateau section and therefore tends to produce a more linear increase in pressure side loading rearwards from the plateau section, as indicated by the dotted line in FIG. 5. Overall, it can be necessary to balance improved mechanical performance (thicker rear part) and improved aerodynamic performance (thinner rear part).

Returning to FIG. 4, in view of the desirability of having an M2 value of 0.8 or more, two blades were experimentally tested at an M2 value of 0.85. These blades are indicated on the plot of FIG. 4 by the data points D1 and D2. D1, which has an uncovered turning of 17°, is a “conventional lift” blade with a conventional value of S/Cₓ, while D2, which has an uncovered turning of 20.2°, exhibits over-diffusion and is a high-lift blade with a higher value of S/Cₓ.

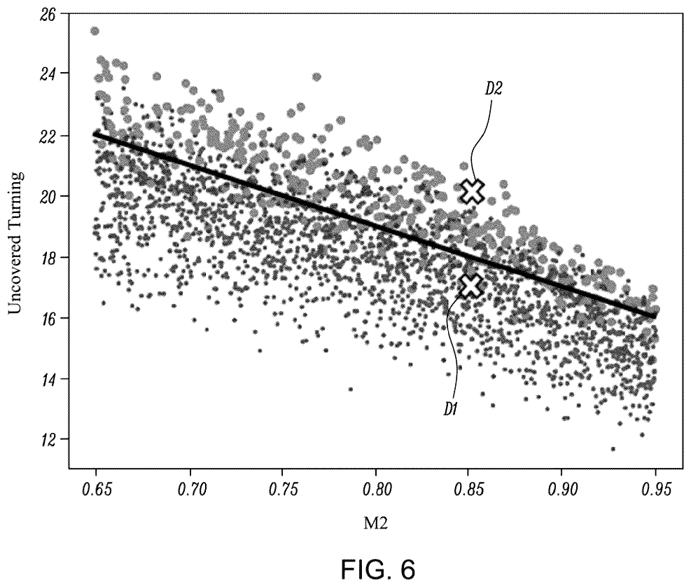

To explore the high value M2 design space more systematically, a further analysis was performed that covered higher M2 values. Specifically, a full inverse 2D CFD, design-of-experiments study was performed to explore different 2D aerofoil sections, each modelled section being required to achieve a desired loading. Once that loading was realised, the uncovered turning and M2 values were extracted from the model. FIG. 6 shows the explored design space and plots uncovered turning against M2. Each larger grey or smaller black circle on the plot is a data point representing a respective modelling run. Two crosses representing D1 and D2 also indicated. The data points were filtered to distinguish higher-lift aerofoil sections (larger grey circles) from more conventional lift aerofoil sections (small black circles). The filtering criteria defining higher-lift in this case were Mₚₑₐₖ/Mₜₑ≥1.35 combined with Mₚₗₐₜ/M1≤0.8, where M1 is the average Mach number on entry into the stage. Any data points not meeting these criteria were identified as conventional lift. As with the FIG. 4 plot, it is clear that (i) the range of uncovered turnings that can achieve a given M2 shifts downwards as M2 increases, and (ii) for each M2 value, higher-lift aerofoil sections (which generally also have higher values of S/Cₓ) predominate at the top of the range while conventional lift aerofoil sections (which generally have lower values of S/Cₓ) predominate at the bottom of the range. The dark line on the plot corresponds to the expression:

$$Uncovered turning in degrees = 35 - {20}^{*} M 2.$$

In general, increased benefits from the over-diffusion approach are seen with greater (vertical) distance above the dark line on the plot of FIG. 6. Thus preferably the uncovered turning angle is greater than or equal to (35.5−20*M2)° and more preferably is greater than or equal to (36−20*M2)°.

As mentioned above, in single stage HP turbines it is desirable for M2 to be about 0.95, whereas in two stage HP turbines it is desirable for M2 to be about 0.8-0.9 for both stages. Accordingly, to achieve over-diffusion and thus a high-lift blade or vane in an HP or IP turbine, the uncovered turning angle should generally be greater than or equal to 16°, but preferably is greater than or equal to 17° or 18°, and more preferably is greater than or equal to 19° or 20°.

Moreover, to fully realise the benefits of over-diffusion in a high-lift blade or vane, this uncovered turning should be combined with a suitably high midspan value of S/Cₓ, thereby reducing blade or vane count to reduce overall weight and cooling requirements. In this respect, the further analysis allows the following empirical expression for the midspan value of S/Cₓ of high-lift HP/IP aerofoil members to be determined as:

$$S / {C}_{x} > 1.4 + 0.04 ( A 2 - 72.5 ) + 0.03 ( M 2 - 0.8 )$$

where A2 is the exit angle of the modelled aerofoil section.

For typical values of A2, this expression indicates that midspan values of S/Cₓ of 1.4 or more can be achieved in high-lift aerofoils, i.e. significantly more than a conventional S/Cₓ value of 1.3. A typical upper limit for the midspan value of S/Cₓ, above which specific fuel consumption may no longer be improved, is about 1.6. However, values of S/Cₓ which are closer to 1.4 may be more practical to implement, and thus S/Cₓ may be 1.4 or more but less than 1.5.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the disclosure in diverse forms thereof.

While the disclosure has been described in conjunction with the exemplary embodiments described above, many equivalent modifications and variations will be apparent to those skilled in the art when given this disclosure. Accordingly, the exemplary embodiments of the disclosure set forth above are considered to be illustrative and not limiting. Various changes to the described embodiments may be made without departing from the spirit and scope of the disclosure.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

We claim

1. An aerofoil component for a high-pressure or intermediate-pressure turbine of a multi-spool gas turbine engine, the component having an aerofoil member which, in use, spans a working gas annulus of the gas turbine engine;
wherein the aerofoil member has a pressure side aerofoil surface and a suction side aerofoil surface which each extend from a leading edge to a trailing edge of the aerofoil member such that transverse cross sections through the aerofoil member provide respective aerofoil sections, the spacing between the leading edge and the trailing edge on the midspan aerofoil section defining a midspan axial chord length, of the aerofoil member, and the aerofoil member being arranged, in use, in a circumferential row around the annulus with plural, equally spaced, identical aerofoil members whereby the circumferential spacing of the aerofoil members at the trailing edges of their midspan aerofoil sections defines a midspan pitch of the aerofoil member; and
wherein the aerofoil member is configured such that at midspan:
the value of S/Cₓ is in the range from 1.4 to 1.6; and
the uncovered turning angle is 16° or more.

2. The aerofoil component of claim 1, wherein the uncovered turning angle is 17° or more.

3. The aerofoil component of claim 2, wherein the uncovered turning angle is 18° or more.

4. The aerofoil component of claim 3, wherein the uncovered turning angle is 19° or more.

5. The aerofoil component of claim 4, wherein the uncovered turning angle is 20° or more.

6. The aerofoil component of claim 1, which is configured such that, when the high-pressure or intermediate-pressure turbine has at least one stage formed by a circumferential row of identical ones of the aerofoil component, the average Mach number, M2, on exit from the or each stage is at least 0.8, M2 being calculated by performing CFD analysis at cruise condition of the gas turbine engine.

7. The aerofoil component of claim 6, which is configured such that, when the high-pressure or intermediate-pressure turbine has at least one stage formed by a circumferential row of identical ones of the aerofoil component, the average Mach number, M2, on exit from the or each stage is at least 0.9, M2 being calculated by performing CFD analysis at cruise condition of the gas turbine engine.

8. The aerofoil component of claim 6, wherein the uncovered turning angle is greater than or equal to (35−20*M2)°.

9. The aerofoil component of claim 8, wherein the uncovered turning angle is greater than or equal to (35.5−20*M2)°.

10. The aerofoil component of claim 9, wherein the uncovered turning angle is greater than or equal to (36−20*M2)°.

11. The aerofoil component of claim 1, wherein the isentropic Mach number on the suction side aerofoil surface of the midspan aerofoil section, calculated by performing CFD analysis at cruise condition of the gas turbine engine, increases from the leading edge to a peak value of Mₚₑₐₖ and then decreases to Mₜₑ at the trailing edge, the value of Mₚₑₐₖ/Mₜₑ being 1.35 or more and Mₜₑ being the time-averaged isentropic Mach number at the trailing edge.

12. An aerofoil component for a high pressure or intermediate-pressure turbine of a multi-spool gas turbine engine, the component having an aerofoil member which, in use, spans a working gas annulus of the gas turbine engine;
wherein the aerofoil member has a pressure side aerofoil surface and a suction side aerofoil surface which each extend from a leading edge to a trailing edge of the aerofoil member such that transverse cross sections through the aerofoil member provide respective aerofoil sections, the spacing between the leading edge and the trailing edge on the midspan aerofoil section defining a midspan axial chord length of the aerofoil member, and the aerofoil member being arranged, in use, in a circumferential row around the annulus with plural, equally spaced, identical aerofoil members whereby the circumferential spacing of the aerofoil members at the trailing edges of their midspan aerofoil sections defines a midspan pitch of the aerofoil member; and
wherein the aerofoil member is configured such that at midspan:
the value of S/Cₓ is in the range from 1.4 to 1.6; and
the isentropic Mach number on the suction side aerofoil surface of the midspan aerofoil section, calculated by performing CFD analysis at cruise condition of the gas turbine engine, increases from the leading edge to a peak value of Mₚₑₐₖ and then decreases to Mₜₑ at the trailing edge, the value of Mₚₑₐₖ/Mₜₑ being 1.35 or more and Mₜₑ being the time-averaged isentropic Mach number at the trailing edge.

13. The aerofoil component of claim 12, wherein the value of Mₚₑₐₖ/Mₜₑ is 1.65 or less.

14. The aerofoil component of claim 12, wherein, as measured with distance along the midspan axial chord, the distance, Lₚₑₐₖ, of Mₚₑₐₖ from the leading edge is such that Lₚₑₐₖ/Cₓ is 0.6 or less.

15. The aerofoil component claim 12, wherein, as measured with distance along the midspan axial chord, the isentropic Mach number on the pressure side aerofoil surface of the midspan aerofoil section, also calculated by performing CFD analysis at the cruise condition, increases from the leading edge to the beginning of a plateau section of length Lₚₛₑ and then increases again from the end of the plateau section to the trailing edge, the isentropic Mach number on the pressure side aerofoil surface being a substantially constant value Mₚₗₐₜ over the length of the plateau section and Lₚₛₑ/Cₓ being 0.3 or more.

16. The aerofoil component of claim 15, wherein, as measured with distance along the midspan axial chord, Mₚₑₐₖ occurs within the length range of the plateau section.

17. The aerofoil component of claim 16, which is configured such that, when the high-pressure or intermediate-pressure turbine has at least one stage formed by a circumferential row of identical ones of the aerofoil component, the average Mach number, M1, on entry to the or each stage, is such that Mₚₗₐₜ/M1≤0.8, M1 also being calculated by performing CFD analysis at the cruise condition.

18. The aerofoil component of claim 15, which is configured such that, when the high-pressure or intermediate-pressure turbine has at least one stage formed by a circumferential row of identical ones of the aerofoil component, the average Mach number, M1, on entry to the or each stage, is such that Mₚₗₐₜ/M1≤0.8, M1 also being calculated by performing CFD analysis at the cruise condition.

19. A high-pressure or intermediate-pressure turbine of a multi-spool gas turbine engine (10), wherein the high-pressure or intermediate-pressure turbine has at least one stage formed by a circumferential row of identical ones of the aerofoil component of claim 1.
